(19) United States
(12) Patent Application Publication
(10) Pub. No.: US 2026/0246167 A1
(43) Pub. Date: Aug. 20, 2026

(54) PROTECTION FOR AN ELECTRICAL BONDING POINT

(71) Applicant: SAFRAN CABIN FRANCE, Colomiers (FR)

(72) Inventors: Martin STANKE, MOISSY-CRAMAYEL (FR); Antoine LE LAY, MOISSY-CRAMAYEL (FR)

(73) Assignee: SAFRAN CABIN FRANCE, Colomiers (FR)

(21) Appl. No.: 19/146,675

(22) PCT Filed: Jan. 20, 2023
(86) PCT No.: PCT/IB2023/000016

§ 371 Date: Jul. 9, 2025

(51) Int. Cl. H01R 4/70; H01R 4/30; H01R 43/00

(52) U.S. Cl. CPC H01R 4/70; H01R 4/305; H01R 43/005

(57) ABSTRACT

A protection for a bonding point between a bonding conductor and a conducting part includes a cover configured for at least partially surrounding the bonding point. The cover
has a first end portion that includes a first passage for the bonding conductor and
a second end portion that includes a second passage for a conductor forming the bonding point and a boundary that is configured to sealingly contact the conducting part.

The protection further includes mechanical coupling means for coupling the cover to the bonding point. The boundary sealingly contacts the conducting part when the cover is coupled to the bonding point via the mechanical coupling means.

### FIELD OF THE INVENTION

The present invention relates to a protection for an electrical bonding point, and in particular to an air-tight protection for an electrical bonding point. The invention also relates to a set and a method for assembling and protecting a mechanical connection between a first and a second electrical conductors at a connecting bonding point.

### BACKGROUND OF THE INVENTION

Bonding is the joining of two conductors together, that may be two pieces of equipment, pipes, enclosures, or structures. Bonding is also referred to as electrical bonding, or grounding when the bonded system is connected to the earth. Bonding typically consists in connecting two non-current-carrying conductive elements using a conductor that is mechanically coupled to each of the conductive elements at respective bonding points.

Many bonding points are mounted on monuments and fuselage of aircrafts, boats, train, buses and public transportation vehicles. Bonding points are on appliances like coffee makers or ovens, galleys, lavatories, lights, ventilation systems, plumbing or other mechanical systems which need to be electrically connected together. In particular, regulations impose strict rules on the grounding points used to connect electrically variable parts. This ensures that current goes directly to the ground and protects electronics and humans against high voltage in case of lightning or other electrical event.

Very low resistance at the interface between conductors at bonding points is required in order to reduce overheating of the bonding points when current is going through. In order to keep the low resistivity, there is a concern for eliminating electro corrosion on contact surfaces at the interface between conductors at bonding points. Electro corrosion is also referred to as galvanic corrosion or dissimilar metal corrosion.

To avoid electro corrosion, bonding points can be painted. This prevents humidity, and in particular air carrying moisture, from reaching the contact surfaces between conductors at the bonding point. However, such paint involves chemicals that are harmful for the environment. The painting operation also adds significant cost and time delays to the installation of the bonding points. Indeed, surfaces must be prepared or cleaned before applying the paint, adjacent parts must be protected from the paint, and many layers of paint are often required. Furthermore, visual inspection or measurements at the bonding point implies removing at least partially the paint, such that the painting operation must be repeated.

There exists a need in the art for protecting means to protect bonding points from humidity without paint. In particular, there is a need for such protecting means with reduced installation time.

### SUMMARY OF THE INVENTION

An object of the invention is to provide a protection for protecting a mechanical connection between a first and a second electrical conductors at a connecting bonding point.

According to this first aspect, the invention provides a protection or protection set comprising:
a cover for enclosing at least partially the mechanical connection at the connecting bonding point when the first and second electrical conductors are mechanically coupled, said cover comprising:
   a first end portion comprising a first passage for the first electrical conductor;
   a second end portion having a boundary configured for contacting the second electrical conductor at least in part sealingly, when the cover is enclosing at least partially the mechanical connection;
mechanical coupling means for mechanically coupling the cover to the mechanical connection.

The protection can also be referred to as a protection set. The connecting bonding point can also be referred to as an electrical bonding point, or simply a bonding point.

The use of the cover and of the mechanical coupling means eliminates the need of painting the bonding point and thus reduces the use of chemicals. Furthermore, the installation time of the cover and the mechanical coupling means is drastically lower in comparison with the painting operation. For example, parts adjacent to the bonding point need no protection from paint projections or splashes, and paint drying time is eliminated.

In the present document, the term ‘sealingly’ is used as a synonym of the term ‘air-tightly’. This is to describe a contact interface or a portion of a contact interface between two parts that prevents the passage of air, in particular air carrying moisture. For example, such contact interface or portion of contact interface can prevent the passage of humidity and liquids.

In an embodiment, the first passage is configured for passing the first electrical conductor that is a bonding conductor. Preferably, the bonding conductor is an electrical cable. Preferably, the electrical cable is surrounded by an electrically insulating sheath. Preferably, the first electrical conductor comprises an end terminal for mechanically connecting to the connecting bonding point. In an example, the end terminal is a lug, a ring terminal, or a fork terminal. Preferably, the end terminal is a ring terminal.

The bonding conductor is typically a flexible electrical cable or wire for electrically connecting two parts. The bonding conductor usually has two end terminals for connecting electrically and mechanically to each of the two parts via respective bonding points. The first electrical conductor preferably comprises a surrounding sheath for electrical insulation or for prevention of corrosion, or for both electrical insulation and prevention of corrosion.

In an embodiment, the first passage for the first electrical conductor comprises a seal portion configured for sealingly surrounding a circumference of the first electrical conductor when the first electrical conductor passes through the first passage. Preferably, a cross section of the first electrical conductor is circular, and the seal portion preferably has a symmetry of revolution around an axis of the first passage for enhanced mating and air-tightness between the seal portion and the first electrical conductor. The seal portion preferably comprises an annular projection extending radially inward from an internal surface of the first passage.

In an embodiment, the seal portion is made of resilient material preferably allowing large elastic deformations without deforming plastically. The seal portion is preferably made of rubber or silicone. The seal portion is preferably configured such that it has an internal diameter at rest slightly lower than an external diameter of the first electrical conductor at a level of the circumference of the first electrical conductor. The internal diameter at rest of the seal portion correspond to the internal diameter of the seal portion when no external force other than gravity is applied on it. In this way, the seal portion slightly deforms and applies a pressure on the circumference of the first electrical conductor when the first electrical conductor passes therethrough, such that air tightness is enhanced.

Preferably, the seal portion comprises a plurality of the annular projections extending radially inward from the internal surface of the first passage. The plurality of the annular projection can be configured for sealingly surrounding a plurality of corresponding circumferences of the first electrical conductor. The plurality of corresponding circumferences are preferably distributed along a length of the first electrical conductor. In this way, they form successive seals preventing the passage of humidity. This enhances air tightness between the cover and the first electrical conductor.

In an example, the external surface of the first conductor or sheath is smooth. It is preferably continuous i.e., preferably not porous and not woven. This enhances air-tightness between the first electrical conductor and the seal portion.

In an embodiment, the first passage is configured for allowing a threading of the first electrical conductor in the first passage. This allows for easily adjusting a position of the cover along the first electrical conductor.

In some cases, the first electrical conductor comprises a cable and an end terminal having a transversal dimension larger than the circumference of the cable. The transversal dimension is measured in a direction orthogonal to the longitudinal direction of the cable at a level of the end terminal. In such case, the seal portion can be too narrow for inserting the end terminal, in particular when the seal portion is configured for sealingly surrounding a circumference of the cable. Thus, the seal portion is preferably configured for deforming to allow inserting the end terminal therethrough. Preferably, both the seal portion and the first passage are preferably configured for deforming to allow inserting the end terminal therethrough.

In an embodiment, the protection is configured for protecting the mechanical connection between the first electrical conductor and the second electrical conductor being a conducting part. The boundary of the second end portion is preferably configured for contacting the conducting part at a contact surface of the conducting part. A portion of the conducting part comprising the contact surface is preferably planar. The entire contact surface is preferably planar. For example, the conducting part can be a panel, a beam, a structural element or frame.

In the context of the present document, the second electrical conductor is typically a non-current-carrying conducting part that is electrically bonded to another part via the bonding conductor. The second electrical conductor can also comprise non-conducting material or parts. For example, the second electrical conductor can be a metallic plate covered with a paint which is not necessarily electrically conducting, and the contact surface is covered by a layer of the paint. In this case, electrical connection with the second electrical conductor can for example be achieved by contacting another surface of the metallic plate which is not covered by electrically insulating paint.

In other words, this means that:
the second electrical conductor necessarily comprises electrically conducting material to be electrically bonded via the bonding point,
the second electrical conductor can also comprise non electrically conducting material such as paint covering the conducting material or plastic parts rigidly attached to the conducting material,
the contact surface of the second conductor can belong to the electrically conducting material of the second conductor, or to the electrically insulating material of the second conductor.

The protection according to the invention is configured for protecting the mechanical connection between the first electrical conductor and the second electrical conductors at the connecting bonding point. For example, the mechanical connection can be an assembly of a plurality of bonding point members comprising the first and second electrical conductors, a nut and a stud.

In an example, the bonding point comprises:
a slug traversed by a hole and forming the end of the first electrical conductor,
the second electrical conductor comprising a traversing hole,
a bolt passing through the holes of the slug and the second electrical conductor,
a nut coupled to a threaded portion of the bolt such that the slug and the second electrical conductor are fastened together and tightened against each other by the nut coupled to the bolt.

In the previous example, the conducting path can be formed by, successively: the slug in contact with the nut, the nut in contact with the bolt, a head of the bolt in contact with the second electrical conductor i.e., with an electrically conducting surface of the second electrical conductor.

In an embodiment of the protection according to the invention, the second end portion comprises a second passage. The second passage is preferably configured for passing one or more bonding point members such as a stud, a washer, or a nut.

Preferably, the boundary configured for contacting the second electrical conductor is surrounding the second passage. The boundary is preferably comprised in a plane when at rest i.e., when no external force other than gravity is applied on it. This enhances air-tightness between the boundary and the second electrical conductor when the contact surface of the second conductor is planar.

In an embodiment, the boundary is an annular projection extending at least radially outward from an external surface of the second end portion, preferably at a level of the second passage.

The second passage preferably extends along a central axis. The boundary preferably has a shape of a section of a cone extending radially outward from the external surface of the second passage, and extending axially along the central axis of the second passage. Preferably, a largest diameter of the section of the cone forms a tip or end of the cover along the axis of the second passage.

In an embodiment, the boundary is made of resilient material allowing large elastic deformation without deforming plastically, preferably of rubber or silicone. This enhances air-tightness of a contact interface between the boundary and the second electrical conductor.

In an embodiment, the boundary is configured for sealingly contacting the second electrical conductor when the cover is mechanically coupled to the mechanical connection via the mechanical coupling means. Preferably, the boundary made of resilient material is configured for deforming against, and preferably applying a pressure on, the second electrical conductor when the cover is mechanically coupled to the mechanical connection via the mechanical coupling means. This improves air-tightness at the contact interface between the boundary and the second electrical conductor.

Preferably, the boundary is configured for sealingly contacting the second electrical conductor continuously along a closed path surrounding the second passage when the cover is mechanically coupled to the mechanical connection via the mechanical coupling means.

In an embodiment, the mechanical coupling means comprise a washer and a washer coupling portion of the cover. The washer coupling portion of the cover is configured for mechanically coupling to the washer when the washer is mechanically coupled to the first and second electrical conductors.

Preferably, the mechanical coupling means are removable, such that the washer and the washer coupling portion of the cover can be mechanically coupled and uncoupled.

Preferably, the washer is configured for rigidly coupling to the first and the second electrical conductors at the connecting bonding point. The washer can be made of electrically conducting material, for example a metal. The washer can be made of electrically insulating material, for example a polymer.

Preferably, the washer is configured such that it is in contact with the second electrical conductor when rigidly coupled to the first and second electrical conductors.

Preferably, the washer coupling portion of the cover has a shape configured for mechanically coupling to the washer. Preferably, the washer coupling portion belongs to the second end portion of the cover.

In an embodiment, the washer coupling portion of the cover is an annular projection extending radially inwards from an internal surface of the second passage.

In an embodiment, the washer has a radial recess configured for receiving the annular projection of the washer coupling portion when the second end portion is coupled to the washer.

In an embodiment, the washer has a symmetry of revolution around a washer axis traversing a central hole of the washer. Preferably, the washer is symmetric with respect to a plane of symmetry of the washer normal to the washer axis. Preferably, the washer comprises a shoulder extending radially outwards and forming a portion of the washer most remote radially from the washer axis. Preferably, the washer comprises two radial recesses adjacent to the shoulder and each configured for receiving the annular projection of the washer coupling portion. This avoids errors when assembling the bonding point because flipping the washer by 180° along an axis comprised in the plane of symmetry of the washer has no effect on the assembly.

In an embodiment, the cover is a single part made of a resilient material allowing large elastic deformation without deforming plastically, preferably of rubber or silicone. This enhances air-tightness and allows producing the cover cost-effectively.

Preferably, the cover comprises only two openings that are the first and second passages. Preferably, the cover is configured for fully enclosing the mechanical connection except at a level of the first and second passages. In this way, the mechanical connection at the bonding point is fully and air-tightly enclosed when:
the seal portion of the first passage is sealingly surrounding a circumference of the first electrical conductor, and
the boundary is surrounding the second passage and sealingly contacting the second electrical conductor.

Of course, such full and sealing enclosure of the mechanical connection can only be achieved if no humidity can enter in the enclosure through the first passage by traversing the first electrical conductor, and through the second passage by traversing the second electrical conductor.

In a second aspect, the invention relates to a set for forming and protecting a mechanical connection between a first and a second electrical conductors at a connecting bonding point, the set comprising:
a protection according to the invention when it comprises the washer,
a stud comprising at least a threaded end,
a nut able to be coupled to the threaded end of the stud, wherein the stud and the nut are configured for mechanically coupling the first electrical conductor, the second electrical conductor and the washer together to form the mechanical connection at the connecting bonding point, and wherein the cover is configured for partially enclosing the connecting bonding point when the first electrical conductor passes through the first passage and the cover is mechanically coupled to the washer.

In an embodiment, the set for forming and protecting the mechanical connection also comprises the first conductor. In an embodiment, the first conductor of the set is already inserted in the first passage with the slug ready for connecting to the bonding point. This eases the assembly of the set and thus the bonding operation.

Preferably, the stud is a clinched stud to enhance electrical contact between the second electrical conductor and the stud. Preferably, the nut is a self-locking nut. The cover can also be a protective shoe, or a protective cap, or a housing.

In the context of the present document, silicone is preferably silicone with hardness 60.

In a fourth aspect, the invention relates to a method for forming and protecting a mechanical connection between a first and a second electrical conductors at a connecting bonding point using the set according to the invention. The method comprises the steps of:
fastening the first electrical conductor and the washer to the second electrical conductor,
mechanically coupling the cover with the first electrical conductor passing through its first passage to the washer, such that the boundary is sealingly contacting the second electrical conductor.

In a fourth aspect, the invention relates to an aircraft comprising the protection according to the invention or the set for forming and protecting the mechanical connection according to the invention.

### BRIEF DESCRIPTION OF THE FIGURES

For a better understanding of the present invention, reference will now be made, by way of example, to the accompanying drawings.

FIG. 1 is a cross-sectional view of a cover according to an embodiment of the invention;

FIGS. 2 and 3 are perspective views of the cover of FIG. 1 showing the first and second passages, respectively;

FIG. 4 is a perspective view of a washer according to an embodiment of the invention;

FIG. 5 is a cross-sectional view of a set for forming and protecting a mechanical connection between a first and a second electrical conductors at a connecting bonding point according to an embodiment of the invention, wherein the mechanical connection at the connecting bonding point is protected by the protection according to the invention.

### DESCRIPTION OF THE INVENTION

The present invention will be described with respect to particular embodiments and with reference to certain drawings but the invention is not limited thereto. The described functions are not limited by the described structures. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

On the figures, identical or analogous elements may be referred by a same number.

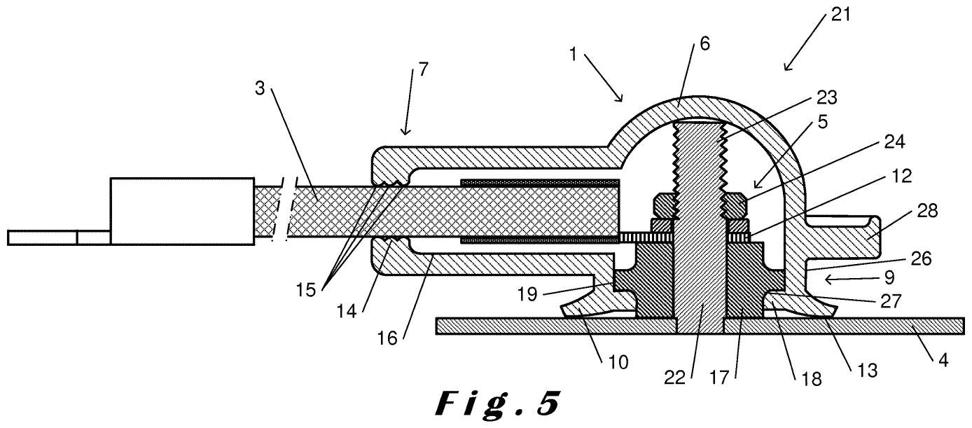

FIG. 1 illustrates a cover 6 according to an embodiment of the invention. As illustrated in FIG. 5, the cover is configured for enclosing at least partially the mechanical connection between a first electrical conductor 3 and a second electrical conductors 4 at a bonding point 5. The cover 6 comprises a first end portion 7 and a second end portion 9.

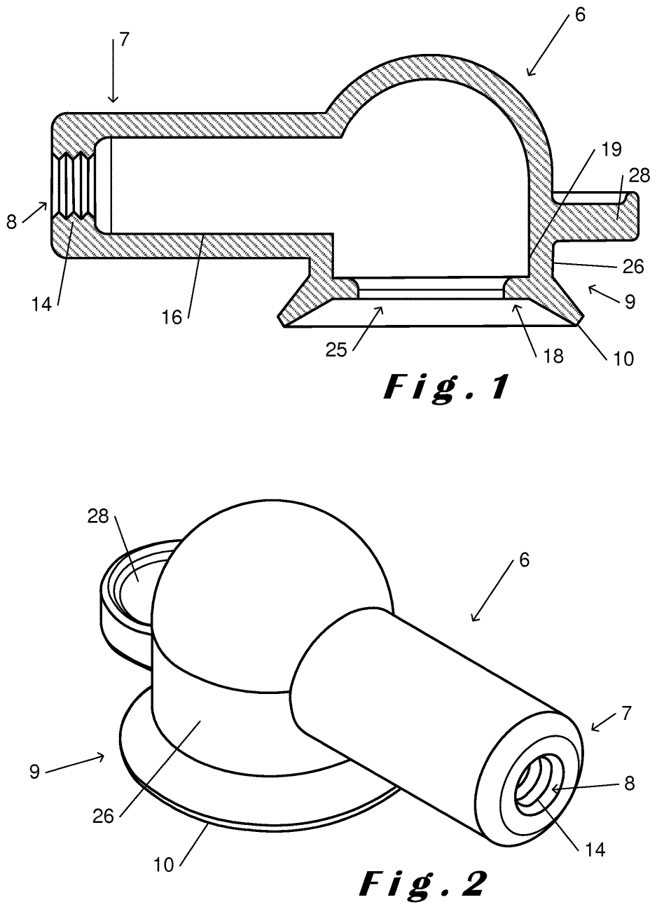

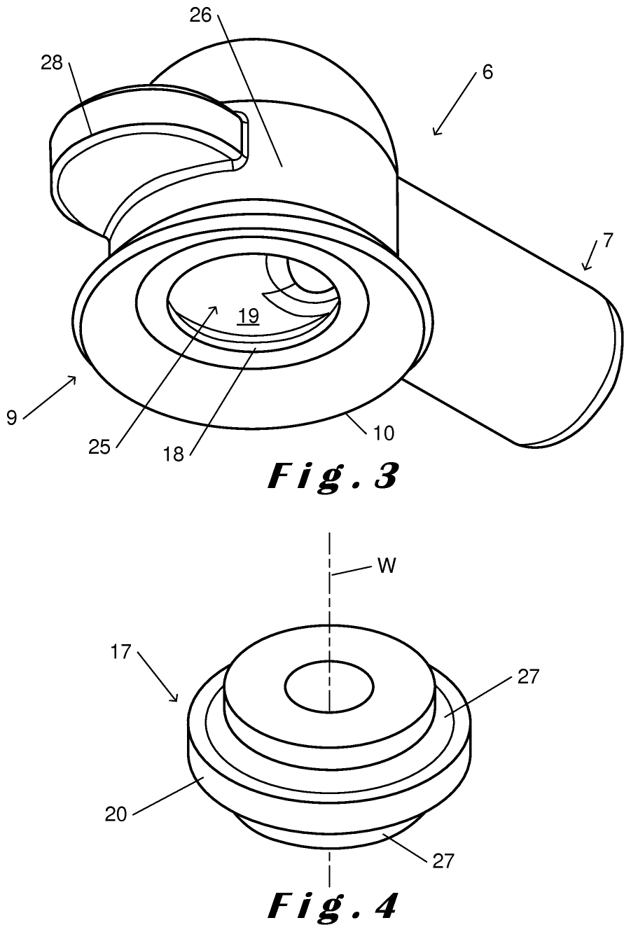

As illustrated in FIGS. 1 and 2, the first end portion 7 comprises a first passage 8 configured for passing the first electrical conductor 3. In an example illustrated in FIG. 5, the first electrical conductor 3 comprises a central portion being a cable having a circular cross section, and an end terminal 12. The end terminal 12 is a ring terminal mechanically and electrically coupled to the cable of the first electrical conductor 3.

To enhance air-tightness of the protection 1, the first passage 8 comprises a seal portion 14. The seal portion 14 is configured for sealingly surrounding a circumference 15 of the first electrical conductor 3. Since the sealing contact surface between the first electrical conductor 3 and the seal portion 14 is continuous at a circumference or periphery of the first electrical conductor 3, no humidity can pass between the first conductor 3 and the seal portion 14.

In the example shown in FIG. 5, the circumference 15 is at a level of the cable and is circular. The seal portion 14 comprises three annular projections extending radially inward from an internal surface 16 of the first passage 8. The three annular projections each sealingly contact a respective circumference 15 belonging to a periphery of the cable and thus form three barriers in series for humidity. This enhances air-tightness of the protection. In the context of the present disclosure, humidity can refer to water, droplets of water, or air carrying moisture.

The cover 6 illustrated in FIGS. 1, 2, and 5 is made of a single part of silicone. The seal portion 14 is thus integral with the cover and made of silicone too.

A problem may arise during the installation of the protection due to the lateral dimensions of the end terminal 12 of the first electrical conductor 3. For example, let us consider the embodiment of the first electrical conductor 3 illustrated in FIG. 5. The first electrical conductor 3 extends along a longitudinal axis and has a diameter of the cable measured in a plane normal to the longitudinal axis which is smaller than the largest lateral dimension of the end terminal 12. The lateral dimension is measured along a lateral axis which is orthogonal to the longitudinal axis of the first electrical conductor at a level of the end terminal 12. In this case, the seal portion made of resilient material such as silicone allows for large elastic deformation of the seal portion can be deformed to allow inserting the end terminal 12 in the first passage 8. For example, the seal portion 14 is configured for allowing pinching by an operator such that the seal portion 14 changes from a circular shape to an oval shape. In the embodiment of FIG. 1, the first end portion 7 and the first passage 8 are also flexible such that larger deformations of the seal portion 14 is possible.

In the embodiment of FIGS. 1, 2, and 5, the seal portion 14 has an internal diameter at rest that is slightly lower than the external diameter of the cable. Preferably, a difference between the internal diameter at rest of the seal portion and the external diameter of the first electrical conductor at a level of the circumference 15 is comprised between 1 mm and 5 mm, preferably between 1.5 mm and 3 mm. This enhances air-tightness between the first electrical conductor 3 and the seal portion 14, because the seal portion 14 will deform upon contacting the cable such that a contact pressure arises at the contact interface between the seal portion 14 and the cable.

The use of the seal portion made of silicone or rubber ensures air-tightness at the contact interface between the cover 6 and the first electrical conductor 3 without requiring any glue or other materials strongly adhering to the periphery of the external conductor. This simplifies the installation of the protection. This also allows for threading the cover 6 along the first electrical conductor 3 passing through the first passage 8 and contacting the seal portion 14 to adjust the position of the cover 6 along the first electrical conductor 3 during installation. This further allows for threading the cover 6 away from the bonding point 5 during inspection and quality control electrical measurements at the bonding point 5.

As illustrated in FIG. 3, the cover 6 comprises a second end portion 9. A boundary 10 of the second end portion 9 is configured for contacting the second electrical conductor 4 at least in part sealingly. Preferably, the boundary 10 is configured for contacting a contact surface 13 of the conducting part which is substantially planar.

As illustrated in the embodiment of FIGS. 1 and 3, the second end portion 9 comprises a second passage 25 for passing one or more members forming the bonding point, such as a washer 17 or a stud 22. The boundary 10 is preferably extending circumferentially around the second passage 25 and configured for contacting the second electrical conductor continuously along a path surrounding the second passage for enhanced air-tightness.

As illustrated in the embodiment of FIGS. 1 and 3, the second end portion comprises a projection extending circumferentially around the second passage 25 and forming the boundary. The boundary preferably forms an extremal end of the cover 6. The boundary 10 is shaped similar to a frustum of a cone projecting out of an external surface 26 of the second end portion 9. The frustum of the cone extends both radially outwards and axially along a central axis of the second passage, and is arranged such that a largest diameter of the cone frustum is at the boundary.

As illustrated in the embodiment of FIG. 5, the protection comprises mechanical coupling means configured for mechanically coupling the cover 6 to the mechanical connection. Preferably, the mechanical coupling means are comprised in the second end portion 9 and in one of the members mechanically coupled to form the bonding point 5.

In the embodiment of FIG. 5, the mechanical coupling means comprises a washer 17 and a washer coupling portion 18 of the cover 6. The washer coupling portion 18 is comprised in the second end portion 9 and consists of an annular projection extending radially inward from an internal surface 19 of the second passage 16. The washer coupling portion 18 has a shape such that it is configured for mating with the washer for mechanically coupling the cover to the washer 17.

As illustrated in FIG. 5, the washer 17 is mechanically coupled to the first and the second electrical conductors 3, 4 when the connecting bonding point is installed. The boundary 10 of the cover is configured for sealingly contacting the second electrical conductor 4 when the annular projection of the washer coupling portion 18 is received in the recess of the washer 17. In this way, there is no gap between the second electrical conductor 4 and the boundary 10, such that no humidity can flow therebetween.

As illustrated in FIG. 5, the boundary 10 made of resilient material is pressed against the second electrical conductor 4 when the annular projection of the washer coupling portion 18 is received in the recess of the washer 17, such that the boundary 10 deforms elastically under a reaction force of the second electrical conductor 4. This enhances air-tightness of the contact interface between the boundary of the cover 6 and the second electrical conductor 4.

As illustrated in FIGS. 4 and 5, the washer 17 is symmetric around a washer axis concentric with a central hole of the washer 17. The washer is comprises a shoulder 20 extending radially outwards from the washer axis and forming a portion of the washer most remote radially from the washer axis W. The washer 17 comprises two radial recesses adjacent to the shoulder 20 and extending circumferentially around the axis W. The radial recesses 27 are each configured for receiving the annular projection of the washer coupling portion 18 of the cover.

The washer 17 is symmetric with respect to a plane of symmetry of the washer that is normal to the washer axis W, such that flipping the washer by 180° or pi radians around an axis comprised in the plane of symmetry of the washer has no impact when assembling the bonding point. This reduces the risk of errors when assembling the members of the bonding point and the protection thereof.

In the embodiment of FIG. 5, the connecting bonding point 5 is an assembly of a number of bonding point members comprising the ring terminal 12 of the first electrical conductor 3, the washer 17 and the second electrical conductor 4 being a metal plate. A clinching stud 22 passes through, in the following order, a hole of the metal plate 4, the washer 17, the ring terminal 12, an optional washer, and a self-locking nut 24. A thread of the self-locking nut is coupled to a threaded end 23 of the stud 22 and tightened such that the bonding point members are fastened against each other and form a rigid assembly. In this case, the conducting path for the bonding is formed by: the end terminal 12 in electrical contact with the optional washer, the optional washer in electrical contact with the nut 24, the nut 24 in electrical contact with the stud 22, and a head of the stud (not represented in FIG. 5) in electrical contact with the metal plate of the second electrical conductor 4.

In the embodiment of FIG. 5, no air can flow between the stud 23 and the plate 4 and enter the enclosure through the hole of the plate 4.

As illustrated in the embodiment of FIG. 5, the cover 6 is preferably configured for enclosing the mechanical connection between the first and second electrical conductors 3, 4 at the connecting bonding point 5, except at the first and second passage 8, 25. The seal portion 14 of the cover is sealingly surrounding the first electrical conductor 3 and the boundary 10 is sealingly contacting the second conductor. In this way, the cover 6 sealingly encloses the bonding point 5 in combination with the first and second conductors 3, 4 when the cover 6 is mechanically coupled to the washer 17 and the first electrical conductor 3 passes through the first passage 8.

As illustrated in FIG. 1, a handle 28 is advantageously provided on an external surface of the cover 6 and is preferably opposed to the first end portion 7 for allowing an easy gripping of the cover 6 by an operator. This enhances the coupling and uncoupling of the cover with the washer.

The mechanical connection between the first and second electrical conductors 3, 4 at the connecting bonding point 5 can be achieved by fastening the first electrical conductor 3, the second electrical conductor 4 and the washer 17 altogether. Then, the mechanical connection at the bonding point 5 can be protected by coupling the cover 6 to the washer 17 such that the boundary 10 is sealingly contact the second electrical conductor. Preferably, the first electrical conductor 3 is inserted in the first passage before coupling the first electrical conductor 3 at the connecting bonding point 5.

The purpose of this invention is to provide a simply flexible silicone housing (shoe) which covers the complete bonding point and surface around to protect it against humidity. This system will dramatically reduce installation time and protect the environment, by avoiding use of chemicals. The protection can be removed and installed back easily for purpose of measurement, etc. without doing any repainting or other additional action.

The present invention relates to a protection for a bonding point between a bonding conductor and a conducting part. The protection comprises a cover configured for at least partially surrounding the bonding point. The cover comprises:
a first end portion comprising a first passage for the bonding conductor,
a second end portion comprising a second passage for a conductor forming the bonding point and a boundary configured for sealingly contacting the conducting part.

The protection further comprises mechanical coupling means for coupling the cover to the bonding point, such that the boundary is sealingly contacting the conducting part when the cover is coupled to the bonding point via the mechanical coupling means. The invention further relate to a set of parts for forming and protecting the bonding point and to a method for performing the same.

Although the present invention has been described above with respect to particular embodiments, it will readily be appreciated that other embodiments are also possible. In particular, examples are not limiting and that equivalents could be envisaged without departing from the essence of the invention. The functions are not limited by the structures provided in the present document.

1. A protector for protecting a mechanical connection between a first electrical conductor and a second electrical conductor at a connecting bonding point, the protector comprising:
a cover configured to enclose at least partially the mechanical connection at the connecting bonding point when the first and second electrical conductors are mechanically coupled, said cover comprising:
a first end portion comprising a first passage for the first electrical conductor; and
a second end portion having a boundary configured for to contact the second electrical conductor at least in part sealingly, when the cover is enclosing at least partially the mechanical connection; and
mechanical coupling means configured to mechanically couple the cover to the mechanical connection.

2. The protection according to claim 1, wherein the first passage is configured to pass the first electrical conductor, which is an electrical cable surrounded by an electrically insulating sheath, the first electrical conductor comprising an end terminal configured to mechanically connect to the connecting bonding point.

3. The protection according to claim 1, wherein the first passage comprises a seal portion configured for sealingly surrounding a circumference of the first electrical conductor when the first electrical conductor passes through the first passage the

4. The protection according to claim 3, wherein the seal portion is made of resilient material.

5. The protection according to claim 1, wherein the first passage is configured to allow a threading of the first electrical conductor in the first passage.

6. The protection according to claim 1, wherein the boundary is configured to contact a contact surface of the second electrical conductor.

7. The protection according to claim 1, wherein the second end portion comprises a second passage.

8. The protection according to claim 1, wherein the boundary is an annular projection extending at least radially outward from an external surface of the second end portion.

9. The protection according to claim 1, wherein the boundary is made of resilient material allowing large elastic deformation without deforming plastically.

10. The protection according to claim 1, wherein the cover is a single part made of resilient material allowing large elastic deformation without deforming plastically.

11. The protection according to claim 1, wherein the boundary is configured for sealingly contacting the second electrical conductor when the cover is mechanically coupled to the mechanical connection via the mechanical coupling means.

12. The protection according to claim 1, wherein the mechanical coupling means comprises:
a washer configured to be mechanically coupled to the first and the second electrical conductors at the connecting bonding point, and
a washer coupling portion of the second end portion having a shape configured to be mechanically coupled to the washer when the washer is mechanically coupled to the first and second electrical conductors.

13. The protection according to claim 12, wherein:
the washer coupling portion of the second end portion is an annular projection extending radially inward from an internal surface of the second passage, and
the washer has a radial recess configured for receiving the annular projection of the washer coupling portion of the second end portion when the second end portion is coupled to the washer.

14. The protection according to claim 12, wherein the washer:
has a symmetry of revolution around a washer axis (W) traversing a central hole of the washer,
is symmetric with respect to a plane of symmetry of the washer normal to the washer axis (W), and
comprises a shoulder extending radially outwards and forming a portion of the washer most remote radially from the washer axis (W), and two radial recesses adjacent to the shoulder.

15. A set for forming and protecting a mechanical connection between a first electrical conductor and a second electrical conductor at a connecting bonding point, the set comprising:
the protection according to claim 12,
a stud comprising at least a threaded end, and
a nut configured to be coupled to the threaded end of the stud,
wherein the stud and the nut are configured to mechanically couple the first electrical conductor, the second electrical conductor and the washer together to form the connecting bonding point,
and wherein the cover is configured to partially enclose the connecting bonding point when the first electrical conductor passes through the first passage and the cover is mechanically coupled to the washer.

16. A method for assembling and protecting a mechanical connection between a first electrical conductor and a second electrical conductor at a connecting bonding point using the set according to claim 15, the method comprising the steps of:
fastening the first electrical conductor, the second electrical conductor and the washer together, and
mechanically coupling the cover with the first electrical conductor passing through the first passage to the washer, such that the boundary is sealingly contacting the second electrical conductor.

17. The protection according to claim 3, wherein the seal portion preferably comprises an annular projection extending radially inward from an internal surface of the first passage.

18. The protection according to claim 4, wherein the seal portion has an internal diameter at rest slightly lower than an external diameter of the first electrical conductor at a level of the circumference of the first electrical conductor.

19. The protection according to claim 6, wherein the contact surface is planar.

20. The protection according to claim 7, wherein the boundary surrounds the second passage and comprises in a plane.
